(19) United States
(12) Patent Application Publication
(10) Pub. No.: US 2017/0097027 A1
(43) Pub. Date: Apr. 6, 2017

(54) Method for Pressing a Ball Together with a First Component, and a Component Connection

(71) Applicant: Bayerische Motoren Werke Aktiengesellschaft, Muenchen (DE)

(72) Inventors: Christian WALDHERR, Malgersdorf (DE); Richard WEIZENBERGER, Aidenbach (DE); Johann VAN NIEKERK, Muenchen (DE)

(21) Appl. No.: 15/381,189

(22) Filed: Dec. 16, 2016

Related U.S. Application Data
(63) Continuation of application No. PCT/EP2015/062114, filed on Jun. 1, 2015.

(30) Foreign Application Priority Data
Jun. 18, 2014 (DE) 10 2014 211 656.2

(51) Int. Cl. F16B 5/08; B60R 21/00

(52) U.S. Cl. CPC F16B 5/08; B60R 21/00

(57) ABSTRACT

A method is provided for pressing a ball into a first component, comprising the acts of: providing a first component, which has a circular through hole; providing a ball, in particular a metal ball, the diameter of which is at most as large as the diameter of the through hole, wherein an inner circumference of the through hole extends up to an outer periphery of the ball; inserting the ball into the through hole such that an equatorial plane of the ball lies in a center plane of the first component; pressing the first component in an edge region of the through hole in such a way that material of the first component flows toward the ball and nestles against the outer periphery of the ball in a tightly contacting manner.

### CROSS REFERENCE TO RELATED APPLICATIONS

This application is a continuation of PCT International Application No. PCT/EP2015/062114, filed Jun. 1, 2015, which claims priority under 35 U.S.C. §119 from German Patent Application No. 10 2014 211 656.2, filed Jun. 18, 2014, the entire disclosures of which are herein expressly incorporated by reference.

### BACKGROUND AND SUMMARY OF THE INVENTION

The present invention relates to a method for press-fitting a ball to a component, and to a component connection.

Component connections having ball-shaped connection elements are known, for example from DE 10 2012 206 938 B3 or DE 10 2012 212 101 B3. Therein, connection elements which are composed of one ball or of a plurality of interconnected balls are used. The connection elements herein are welded to a first component.

It is an object of the invention to provide an alternative method for connecting a connection element to a component, and to provide a component connection which is based on this method.

This and other objects are achieved by a method for pressing a ball into a first component, as well as by the component connection obtained by said method. The method includes providing a first component which has a circular through-bore; providing a ball, in particular a metal ball, the diameter of which is at most equal in size to the diameter of the through-bore, wherein an internal circumference of the through-bore approximates an external circumference of the ball; introducing the ball into the through-bore in such a manner that an equatorial plane of the ball lies in a central plane of the first component; press-fitting the first component in a peripheral region of the through-bore in such a manner that material of the first component flows toward the ball and nestles against the outer periphery of the ball in a tightly contacting manner.

The basic concept of the invention lies in introducing a ball into a bore which is provided in a first component in such a manner that an equatorial plane of the ball in the bore region lies approximately or exactly in a central plane of the first component, and in press-fitting a peripheral region of the through-bore which is provided in the first component such that material of the first component flows toward the ball and nestles against outer periphery of the ball in a tightly contacting manner. On account thereof, a friction fit results between the first component and the ball, and additionally a certain form fit results, on account of which the ball is connected in a translational and fixed manner as well as a rotationally fixed manner to the first component.

The ball may also be referred to as a “connection element”, or the ball may form part of a connection element which is composed of further elements. The term “ball” is not necessarily limited to an exactly spherical geometry in the mathematical sense, but may also comprise elements which are similar to a sphere.

As has already been mentioned, the connection element according to the invention may be composed of a single ball. Alternatively, the connection element may also be composed of two or a plurality of interconnected balls. In the case of a connection element which is composed of two balls, reference may also be made to a “dual ball”. The individual balls of such a connection element may be welded to one another or may be interconnected in another manner. However, a connection element which is composed of a plurality of “part elements” need not necessarily be composed only of balls. A connection element which has one ball or a plurality of balls is also contemplated, wherein another part element such as, for example, a threaded bolt, or a multi-sided element, or similar, protrudes from the ball or from one of the balls.

The method according to the invention for press-fitting a ball, or a connection element which is formed by a ball or which has at least one ball, may be described as follows.

First, a first component which has a circular through-bore is provided. Subsequently, a metal ball, or connection element which has at least one ball, in particular a metal ball, respectively, is provided. The diameter of the ball is at most equal in size to the diameter of the through-bore, but not substantially smaller. An internal circumference of the through-bore thus approximates an external circumference of the ball.

Subsequently, the ball is introduced into the through-bore in such a manner that an equatorial plane of the ball lies approximately or exactly in a central plane of the first component. In other words, the ball on both sides of the first component protrudes approximately or exactly equally therefrom. Subsequently, the first component in a peripheral region of the through-bore is press-fitted in such a manner that material of the first component flows toward the ball and merges tightly into the external circumference of the ball.

It may be provided that, during press-fitting of the first component, material of the first component flows into a region above and into a region below the equatorial plane of the ball and merges into the ball such that, in addition to a friction fit, a certain form fit results between the first component and the ball.

According to one refinement of the invention, press-fitting is performed by use of a press tool which is composed of an upper tool and of a lower tool, wherein the upper tool engages on the first component from a first side of the first component, and the lower tool engages on the first component from a second side of the first component that is opposite to the first side. The upper tool and/or the lower tool may have the shape of a sleeve or of a circular cylinder. A bead-type elevation may be provided on an end side of the upper tool and/or on an end side of the lower tool, said bead-type elevation being embossed into the first component during press-fitting. A flow of material of the first component in the direction toward the ball during press-fitting is supported by way of a bead-type elevation of this type.

During press-fitting, the first component may bear on a supporting die or contact the latter. During press-fitting, the first component may also be clamped between a supporting die and a down-holding device, wherein the supporting die and/or the down-holding device each have one bore or one depression which is larger than the upper tool and the lower tool. The upper tool may thus be received in the down-holding device, and the lower tool may be received in the supporting die.

The first component may be a sheet-metal panel, for example. It is relevant that the material of the first component is a material which has sufficient ductility so as to enable press-fitting, that is to say enable a flow during press-fitting. The connection element or the ball, respectively, may in particular be a metal ball or steel ball, respectively.

In as far as a single ball is press-fitted to the first component, at least one further ball may be welded to the ball prior to or post press-fitting.

As has already been indicated, it may be provided that the ball to be press-fitted to the first component prior to press-fitting is part of a connection element which is composed of at least two balls, or is part of a connection element which apart from the ball to be press-fitted to the first component has a further part.

The ball, post press-fitting of the first component to the ball, may be welded to the first component. For example, the ball may be welded to the first component by way of a closed annular seam. Welding may be performed, for example, by means of a laser welding device which is disposed so as to be remote from the ball.

For the sake of completeness, the component connection according to the invention is to be described in more detail per se. A component connection according to the invention has a first component in which a through-bore is provided. A connection element which is formed by a ball or which has at least one ball, with the through-bore of the first component forms a press-fit connection, wherein the ball protrudes from the first component on both sides of the first component.

Furthermore, the component connection has a second component which has a through-bore or a receptacle opening into which the connection element or the ball, respectively, protrudes. According to the invention, the second component interacts in a form fitting manner with the connection element which is press-fitted in the through-bore of the first component such that the two components at the point at which the connection element protrudes into the through-bore or the clearance, respectively, which is provided in the second component, are mutually centered.

In this manner, two body parts which are to be interconnected in the making of vehicle bodies, for example, may be mutually positioned in a very exact and a simple and efficient manner.

According to one refinement of the invention, the through-bore which is provided in the second component, or the clearance which is provided in the second component, is dimensioned such that a clamping connection results when the two components are plugged together, that is to say when the connection element is plugged into the through-bore or into the clearance of the second component. The two components may thus be clamped together or clip-fitted to one another by way of the connection element.

Alternatively or additionally, a clip element of plastic may also be clip-fitted onto the connection element. The second component per se thus does not necessarily have to be clip-fitted onto the connection element which projects from the first component. A clamping connection between the two components may also be achieved by a clip element which is clip-fitted onto the connection element post assembly of the two components. In this case, the components are held together by the clip element.

In addition to a form fitting clamping connection of this type, the two components may be interconnected in another manner, for example by way of a screw connection, a welded connection, a rivet connection, or similar.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a ball which has been introduced into a through-bore of a first component, prior to press-fitting in accordance with an embodiment of the invention; and

FIG. 2 shows the ball post press-fitting.

### DETAILED DESCRIPTION OF THE DRAWINGS

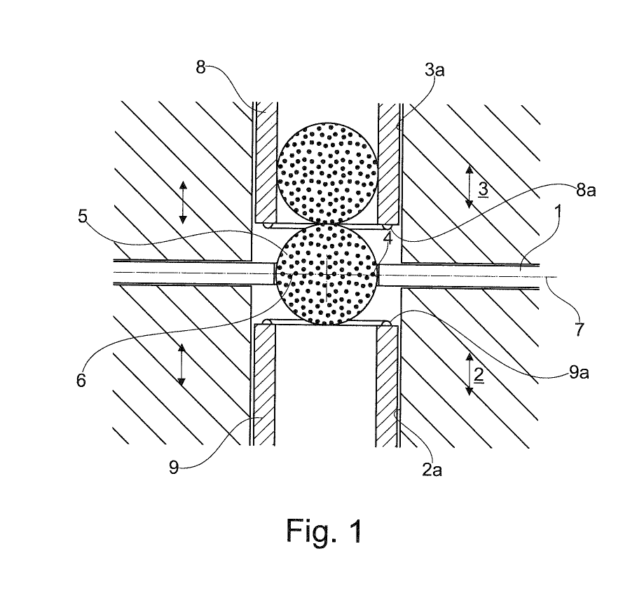

FIG. 1 shows a first component 1 which may be a steel panel or an aluminum panel, for example.

The first component 1 bears on a supporting die 2 and by means of a down-holding (clamping) device 3 is pressed against the supporting die 2. The first component 1 is thus clamped between the supporting die 2 and the down-holding device 3. One clearance 2a or 3a, respectively, is provided in each of the supporting die 2 and the down-holding device 3. The clearances 2a, 3a may be of circular-cylindrical shape, for example.

The first component 1 has a through-bore 4 which is circular-cylindrical in shape. A ball 5 is introduced into the through-bore 4. The ball 5 may be a steel ball, for example. The ball 5 is introduced into the through-bore 4 such that an equatorial plane 6 of the ball 5 lies in a central plane 7 of the first component 1. The ball 5 thus protrudes toward the top and toward the bottom approximately or exactly equally from the through-bore 4 of the first component 1.

As can be seen from FIG. 1, the diameter of the ball 5 is exactly the same size as the diameter of the through-bore 4, or is only slightly smaller than the diameter of the through-bore 4. The periphery of the through-bore 4 thus extends up to the external circumference of the ball 5.

The first component 1 is press-fitted to the ball (5) by way of a sleeve-type upper tool 8 and a sleeve-type lower tool 9. The upper tool 8 is disposed so as to be longitudinally displaceable in the clearance 3a of the down-holding device 3. The lower tool 9 is disposed so as to be displaceable in the clearance 2a of the supporting die 2.

An encircling bead-type elevation 8a is provided on an end side of the upper tool 8. A similar or identical encircling bead-type elevation 9a is provided on an end side of the lower tool 9.

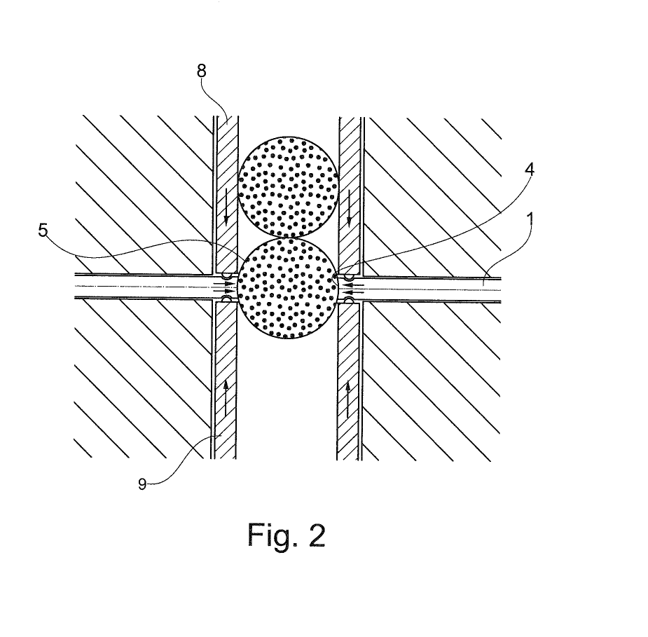

The first component 1 in the peripheral region of the through-bore 4 is press-fitted to the ball 5 by converging the upper tool 8 and the lower tool 9. The bead-type elevations 8a, 9a of the upper tool 8 or of the lower tool 9, respectively, are embossed into the first component and cause a flow of material of the first component 1 toward the ball 5. That material of the first component 1 that flows during press-fitting merges tightly into the external circumference of the ball 5, on account of which a friction fit and, additionally, a certain form fit, results between the first component 1 and the ball 5 as shown in FIG. 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for press-fitting a ball to a first component, the method comprising the acts of:
providing a first component having a circular through-bore;
providing a ball, a diameter of which is at most equal in size to the through-bore, wherein an inner circumference of the through-bore approximates an external circumference of the ball;
introducing the ball into through-bore such that an equatorial plane of the ball lies in a central plane of the first component; and
press-fitting the first component in a peripheral region of the through-bore such that material of the first component flows toward the ball and nestles against an outer periphery of the ball in a tightly contacting manner.

2. The method according to claim 1, wherein during the press-fitting of the first component, the material of the first component flows into a region above and into a region below the equatorial plane of the ball such that, in addition to a friction fit, a form fit is obtained between the first component and the ball.

3. The method according to claim 1, wherein:
the press-fitting is performed via an upper tool and a lower tool,
the upper tool engages on the first component from a first side of the first component, and
the lower tool engages on the first component from a second side of the first component, the second side being opposite the first side.

4. The method according to claim 3, wherein the upper tool and/or the lower tool are configured in a sleeve manner.

5. The method according to claim 3, wherein:
a bead elevation is provided on an end side of the upper tool that bears on the first component and/or a bead elevation is provided on an end side of the lower tool that bears on the first component, and
the bead elevation is embossed into the first component during the act of press-fitting of the first component.

6. The method according to claim 1, wherein the first component is a sheet metal panel.

7. The method according to claim 6, wherein the ball is a metal ball.

8. The method according to claim 1, wherein the ball is a metal ball.

9. The method according to claim 1, further comprising the act of welding at least one further ball to the ball prior to or after the press-fitting.

10. The method according to claim 1, wherein
the ball, prior to the press-fitting, is part of a connection element comprising at least two balls or part of a connection element comprising a further part in addition to the ball to be press-fitted.

11. The method according to claim 1, further comprising the act of welding the ball to the first component after the press-fitting.

12. The method according to claim 11, wherein the welding is carried out via a laser welder disposed remote from the ball.

13. A component connection, comprising:
a first component having a through-bore;
a connection element in a form of at least one ball, the at least one ball of the connection element forming a press-fit connection with the through-bore of the first component; and
a second component having a through-bore, wherein the connection element protrudes into the through-bore of the second component.

14. The component connection according to claim 13, wherein the second component interacts in a form-fitting manner with the connection element such that the first and second components are mutually centered at a point of the connection element.

15. The component connection according to claim 13, wherein the connection element is press-fit in the through-bore of the second component.

16. The component connection according to claim 13, further comprising a plastic clip element that is clip-fit onto the connection element.

17. The component connection according to claim 16, wherein the first and second components are held together by the plastic clip element.

18. The component connection according to claim 13, wherein the first and second components are components of a vehicle.

19. The component connection according to claim 13, wherein the first and second components are vehicle body components.

20. The component connection according to claim 13, wherein the first and second components are additionally welded together.
